(19) United States
(12) Patent Application Publication
(10) Pub. No.: US 2007/0150922 A1
(43) Pub. Date: Jun. 28, 2007

(54) Method and apparatus for transmitting and receiving basic image frames and additional optional frames in satellite digital multimedia broadcasting

(75) Inventors: Jeong-goo Seo, Gyeonggi-do (KR); Jae-hee Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech&Curitel Communications, Inc.

(21) Appl. No.: 11/523,265

(22) Filed: Sep. 18, 2006

(30) Foreign Application Priority Data
Dec. 27, 2005 (KR) 10-2005-0130868

(51) Int. Cl. H04N 7/16

(52) U.S. Cl. 725/62

(57) ABSTRACT

A method of transmitting a basic image frame and an additional optional frame in satellite digital multimedia broadcasting (S-DMB), the method including: (a) generating the basic image frame and the optional frame by encoding an image; (b) packetizing the basic image frame and the optional frame into a transport stream conforming to Motion Pictures Expert Group-2 (MPEG-2) standard and assigning a packet ID to the optional frame packet, the packet ID being different from that of the basic image frame packet; and (c) generating a transport stream from the basic image frame packet and the optional frame packet having the packet ID and transmitting the transport stream.

### BACKGROUND OF THE INVENTION

This application claims the priority of Korean Patent Application No. 2005-130868, filed on Dec. 27, 2005, in the Korean Intellectual Property Office, the disclosure of which is incorporated herein in its entirety by reference.

1. Field of the Invention

The present invention relates to satellite digital multimedia broadcasting (S-DMB) and, more particularly, to a method and apparatus for transmitting and receiving basic image frames and additional optional frames to enhance image quality in S-DMB.

2. Description of Related Art

In general, images are transmitted at a rate of fifteen frames per second in S-DMB, while images are transmitted at a rate of thirty frames per second in terrestrial digital multimedia broadcasting (T-DMB). Since S-DMB uses a code division multiplexing (CDM) method, it has limitations in the number of channels that are simultaneously received and the frame rate.

Thus, for example, when sports events are broadcast, sports images received by a receiving apparatus may not be naturally played.

### SUMMARY OF THE INVENTION

The present invention provides a method and apparatus for transmitting and receiving basic image frames and additional optional frames in satellite digital multimedia broadcasting (S-DMB). That is, when images are encoded and transmitted in S-DMB, fifteen basic image frames and additional optional frames are transmitted and the basic image frames and the optional frames are decoded, thus enhancing the image quality in S-DMB.

According to an aspect of the present invention, there is provided a method of transmitting a basic image frame and an additional optional frame in S-DMB, the method including: (a) generating the basic image frame and the optional frame by encoding an image; (b) packetizing the basic image frame and the optional frame into a transport stream conforming to Motion Pictures Expert Group-2 (MPEG-2) standard and assigning a packet ID to the optional frame packet, the packet ID being different from that of the basic image frame packet; and (c) generating a transport stream from the basic image frame packet and the optional frame packet having the packet ID and transmitting the transport stream.

The method may further include (d) distributing the transport stream to input channels according to packet IDs to perform Code Division Multiplexing (CDM) for S-DMB transmission, the optional frame packet being input to an input channel of the basic image frame packet or to another input channel according to the bit rate of the optional frame packet.

The optional frame may be generated by making reference to the basic image frame and may not be used as a reference frame for generating other frames.

The basic image frame may be an Intra-coded frame (I-frame) or a Predictively coded frame (P-frame), and the optional frame may be a Bidirectionally predicted frame (B-frame).

According to another aspect of the present invention, there is provided a method of receiving S-DMB, the method including: (a) receiving and demodulating code-division-multiplexed S-DMB data according to individual channels; (b) collecting and restoring the demodulated data to a transport stream; (c) demultiplexing and dividing the transport stream into a basic image frame packet and an optional frame packet that have different packet IDs from each other; and (d) decoding both the basic image frame packet and the optional frame packet or only the basic image frame packet to generate an image according to whether or not a receiving apparatus can receive and decode the optional frame.

The optional frame may be generated by making reference to the basic image frame.

According to another aspect of the present invention, there is provided an apparatus for transmitting a basic image frame and an additional optional frame in S-DMB, the apparatus including: a video encoder encoding an image to generate the basic image frame and the optional frame; a packetization unit packetizing the basic image frame and the optional frame into a transport stream conforming to MPEG-2 standard and assigning a packet ID to the optional frame packet, the packet ID being different from that of the basic image frame packet; and a multiplexing unit generating a transport stream from the basic image frame packet and the optional frame packet having the packet ID and transmitting the transport stream.

The apparatus may further include a channel distribution unit distributing the transport stream to input channels according to packet IDs to perform CDM for S-DMB transmission, the optional frame packet being input to an input channel of the basic image frame packet or another input channel according to the bit rate of the optional frame packet.

According to another aspect of the present invention, there is provided an apparatus for receiving S-DMB, including: a CDM demodulation unit receiving and demodulating code-division-multiplexed S-DMB according to individual channels; a packet collecting unit collecting and restoring the demodulated data to a transport stream; a demultiplexing unit demultiplexing and dividing the transport stream into a basic image frame packet and an optional frame packet that have different packet IDs from each other; and a control unit decoding both the basic image frame packet and the optional frame packet or only the basic image frame packet to generate an image according to whether or not a receiving apparatus can receive and decode the optional frame.

### BRIEF DESCRIPTION OF THE DRAWINGS

The above and other features and advantages of the present invention will become more apparent by describing in detail exemplary embodiments thereof with reference to the attached drawings in which:

FIGS. 1A to 1C are views for explaining a process of adding optional frames to basic image frames transmitted in satellite digital multimedia broadcasting (S-DMB) according to an embodiment of the present invention;

FIG. 2 is a block diagram of an apparatus for transmitting basic image frames and additional optional frames according to an embodiment of the present invention;

FIG. 3A illustrates a program map table (PMT) storing information concerning basic image frame packet and optional frame packet;

FIG. 3B illustrates a descriptor describing an optional frame;

FIG. 4 is a block diagram of an apparatus for receiving basic image frames and additional optional frames in S-DMB according to an embodiment of the present invention;

FIG. 5 is a flow chart of a method of transmitting basic image frames and additional optional frames according to an embodiment of the present invention; and

FIG. 6 is a flow chart of a method of receiving basic image frames and additional optional frames in S-DMB according to an embodiment of the present invention.

### DETAILED DESCRIPTION OF THE INVENTION

Exemplary embodiments in accordance with the present invention will now be described in detail with reference to the accompanying drawings.

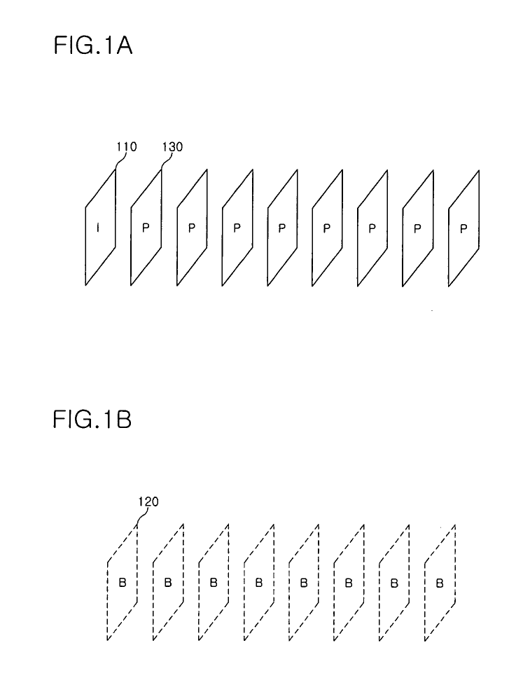

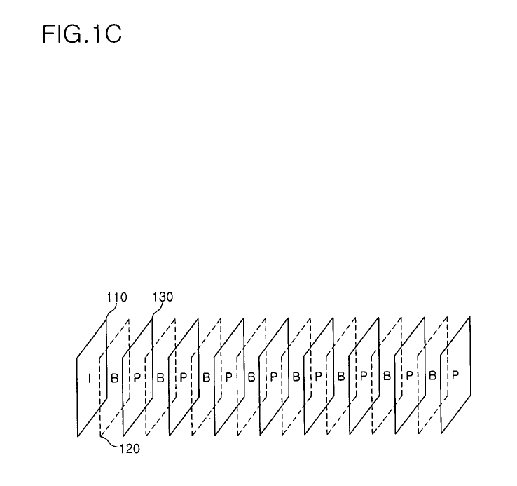

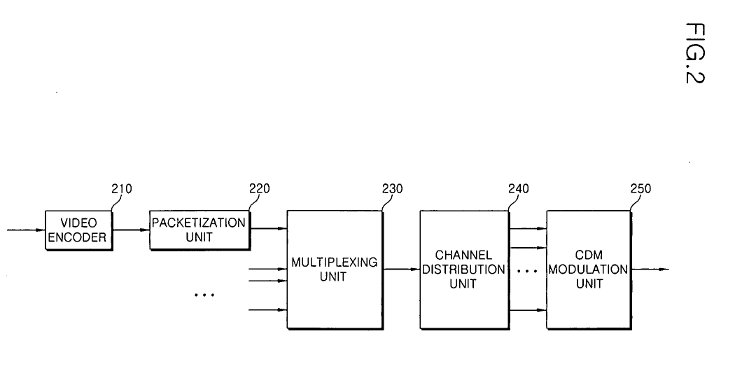

FIGS. 1A to 1C are views for explaining a process of adding optional frames to basic image frames transmitted in satellite digital multimedia broadcasting (S-DMB) according to an embodiment of the present invention.

As shown in FIG. 1A, Intra-coded frame (I-frame) 110 and Predictively coded frame (P-frame) 130 are generated and transmitted to encode and transmit images in S-DMB.

In general, I-frame 110, P-frame 120, and Bidirectionally predicted frame (B-frame) 130 are generated to encode an image according to an MPEG coding method. The I-frame 110 is coded independently of all other frames, the P-frame 120 is coded based on previously coded frame, and B-frame 130 is coded based on both previous and future coded frames.

According to an embodiment of the present invention, the B-frame 120 is inserted as an optional frame between the I-frames 110 and/or the P-frames 130 as shown in FIG. 1B in an S-DMB image consisting of the I-frames 110 and the P-frames 130 as shown in FIG. 1A, such that a moving image having higher frame rate than that of the image shown in FIG. 1A is transmitted as shown in FIG. 1C.

FIG. 2 is a block diagram of an apparatus for transmitting basic image frames and additional optional frames according to an embodiment of the present invention.

A transmitting apparatus according to the present invention includes a video encoder 210, a packetization unit 220, a multiplexing unit 230, a channel distribution unit 240, and a CDM (code division multiplexing) modulation unit 250. The video encoder 210 encodes an image to generate a basic image frame and an optional frame. The basic image frame means a frame transmitted in a conventional S-DMB. For example, the basic image frame includes the I-frame 110 and the P-frame 130 shown in FIG. 1A. The optional frame means an additional frame. For example, the optional frame includes the B-frame 120 shown in FIG. 1B. Data outputted from the encoder 210 is transmitted to the packetization unit 220 and is packetized to generate an MPEG-2 transport stream.

The packetization unit 220 packetizes the basic image frame and the optional frame, which are generated in the encoder 210, to generate an MPEG-2 transport stream and assigns different packet IDs (PIDs) to the respective frames according to the type of frame. Thus, an optional frame packet is assigned a PID different from that of a basic image frame packet.

The multiplexing unit 230 generates an MPEG-2 transport stream from the optional frame packet and the basic image frame packet, which are assigned the PIDs. That is, when there is additional data packetized from other video or audio encoder, the multiplexing unit 230 receives the packetized data and generates a single MPEG-2 transport stream.

The channel distribution unit 240 transmits the MPEG-2 transport stream outputted from the multiplexing unit 230 to input channels of the CDM modulation unit 250, which performs a CDM process to transmit S-DMB, according to the respective PIDs. In S-DMB, payload data, such as the MPEG-2 transport stream, is code-division-multiplexed and transmitted. The CDM modulation unit 250 receives the payload data in packet units through the respective input channels, and code-division-multiplexes and transmits the payload data.

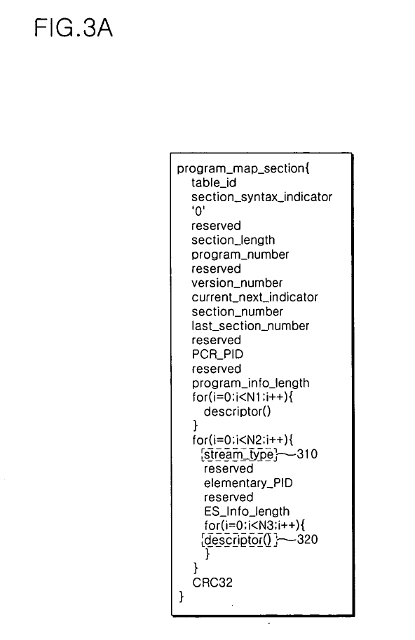

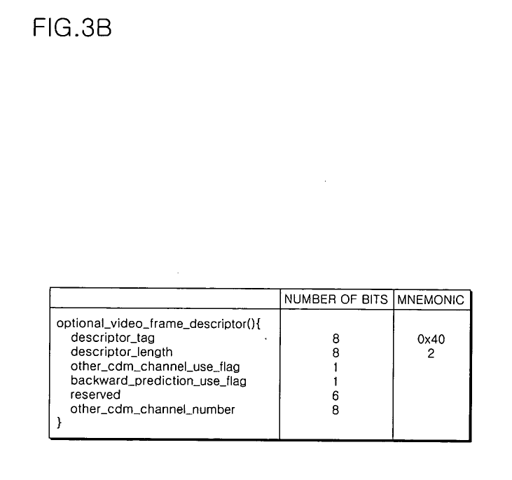

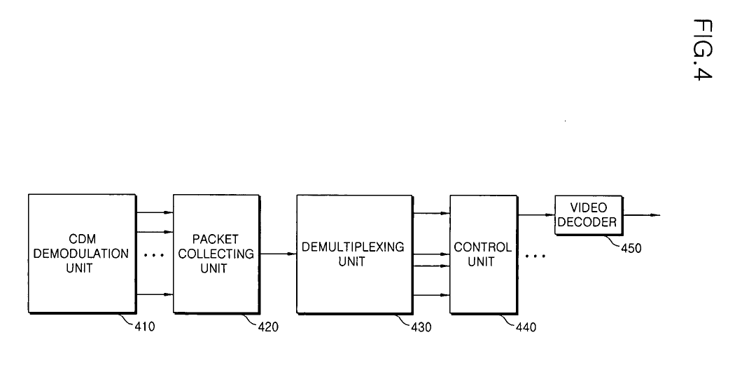

FIG. 3A illustrates a program map table (PMT) storing information concerning basic image frame packet and optional frame packet.

When an image frame is packetized to generate an MPEG-2 transport stream, the MPEG-2 transport stream needs to have information concerning whether individual packets are basic image frame packets or optional frame packets. FIG. 3A illustrates a program map table (PMT) having the information concerning whether individual packets are basic image frame packets or optional frame packets.

Referring to FIG. 3A, there is a field “stream_type” 310 to distinguish an optional frame packet from a basic image frame packet. That is, information concerning the optional frame packet, i.e., a field “stream_type” 310 for the optional frame packet and a field “descriptor” 320 describing the optional frame, is stored in the conventional PMT to further transmit the optional frame.

FIG. 3B illustrates a descriptor 320 describing an optional frame.

Information concerning the optional frame is stored using fields “descriptor_tag”, “descriptor_length”, “other_cdm_channel_use_flag”, “backward_prediction_use_flag”, “reserved”, and “other_cdm channel_number”. The field “other_cdm_channel_use_flag” indicates whether there is a channel other than five CDM channels simultaneously received and decoded by a receiving apparatus and a packet having an optional frame is transmitted on the channel. The field “other_cdm_channel_number” stores a Walsh number of a CDM channel on which the optional frame is transmitted.

For example, when the field “other_cdm_channel_use_flag” is set to 1, a receiving apparatus including a CDM modulation unit having six or more CDM channels that can be simultaneously received and decoded receives and decodes the optional frame. When the field “other_cdm_channel_use_flag” is set to 0, the optional frame is received and decoded regardless of the receiving apparatus. Thus, when the transmitting apparatus generates a PMT, it is determined according to the bit rate of an optional frame whether the optional frame is transmitted through a CDM channel on which a basic image frame is transmitted or whether the optional frame is transmitted through another CDM channel on which the optional frame is transmitted, and data on individual fields of the field “optional_video_frame_descriptor” are determined as shown in FIG. 3B.

When the field “other_cdm_channel_use_flag” is set to 1, the channel distribution unit 240 transmits packets of the optional frame to a CDM channel designated by the field “other_cdm_channel_number”.

FIG. 4 is a block diagram of an apparatus for receiving basic image frames and additional optional frames in S-DMB according to an embodiment of the present invention.

The receiving apparatus includes a CDM demodulation unit 410, a packet collecting unit 420, a demultiplexing unit 430, a control unit 440, and a video decoder 450. The CDM demodulation unit 410 receives code-division-multiplexed S-DMB and demodulates it on individual channels. When the number of CDM channels simultaneously received and decoded is six or more, the optional frame packet can be received regardless of whether the frame “other_cdm_channel_use_flag” is set to 1 or 0. When the number of CDM channels simultaneously received and decoded is five, the optional frame packet can be received only when the field “other_cdm_channel_use_flag” is set to 0.

The packet collecting unit 420 collects and restores the demodulated data to an MPEG-2 transport stream. The demultiplexing unit 430 demultiplexes the MPEG-2 transport stream into a basic image frame packet and an optional frame packet, which have different PIDs.

When the number of CDM channels simultaneously received and decoded is six or more and an optional frame can be decoded, i.e., when the field “stream_type” is set to a value indicating the optional frame and the field “other_cdm_channel_use_flag” is set to 1, a CDM channel corresponding to a Walsh value stored in the field “other_cdm_channel_number” is decoded to decode an optional frame packet received from a CDM channel on which the optional frame is transmitted. When the number of CDM channels simultaneously received and decoded is five and an optional frame can be decoded, i.e., when the field “stream_type” is set to a value indicating the optional frame and the field “other_cdm_channel_use_flag” is set to 0, a packet with packet ID stored in the optional frame packet is transmitted to the control unit 440.

The control unit 440 controls the video decoder 450 to decode both the basic image frame packet and the optional frame packet or only the basic image frame packet to generate an image according to user selection or the capability of the receiving apparatus.

The video decoder 450 does not use the B-frame as a reference frame upon performing a decoding process. When the B-frame is generated through a backward prediction, the field “backward_prediction_use_flag” of FIG. 3B is set to 1, and the P-frame appearing later in FIG. 1C is first decoded. When the B-frame is generated through a forward prediction, the field “backward_prediction_use_flag” of FIG. 3B is set to 0, and frames are decoded in the order of the PTS.

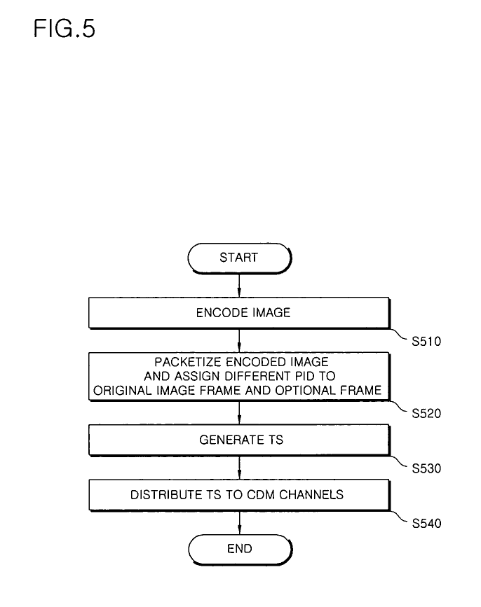

FIG. 5 is a flow chart of a method of transmitting basic image frames and additional optional frames according to an embodiment of the present invention.

An image is encoded to generate a basic image frame and an optional frame (S510). The basic image frame and the optional frame have been described above, and the optional frame may be a B-frame generated by referring to the basic image frame.

The encoded basic image frame and optional frame are packetized, and different PIDs are assigned to basic image frame packets and optional frame packets (S520). An MPEG-2 transport stream is generated from the optional frame packet and the basic image frame packet, which are assigned PIDs (S530). The MPEG-2 transport streams are transmitted to individual channels based on individual PIDs to perform a CDM process for S-DMB (S540)

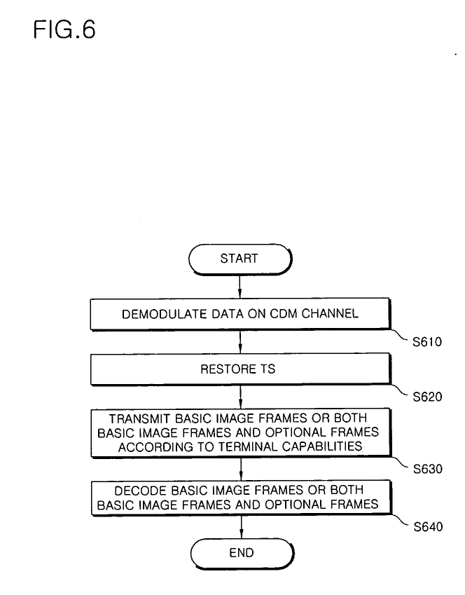

FIG. 6 is a flow chart of a method of receiving basic image frames and additional optional frames in S-DMB according to an embodiment of the present invention.

The code-division-multiplexed S-DMB is received and demodulated on individual channels (S610). The demodulated data is collected and restored to the MPEG-2 transport stream (S620).

The MPEG-2 transport stream is demultiplexed into a basic image frame packet and an optional frame packet, which have different PIDs from each other (S630). The basic image frame packet and the optional frame packet are transmitted to the decoder, and both the basic image frame packet and the optional frame packet are decoded or only the basic image frame packet is decoded to generate an image according to user selection or the capability of a receiving apparatus (S640).

The above-mentioned transmitting and receiving methods can be written with computer programs. Codes and code segments constituting the programs can be easily deduced by computer programmers in the art. The programs are stored in computer readable media and are executed by computers to perform the transmitting and receiving methods. Examples of the computer readable media include magnetic recording media, optical recording media, and carrier wave media.

As apparent from the above description, the transmitting apparatus further transmits additional optional frames, and the receiving apparatus receiving and decoding the optional frames decodes and plays the optional frames together with the basic image frames to obtain natural images. On the other hand, the conventional receiving apparatus that can not receive and decode the optional frames can receive such a service image without modifying software or hardware, thereby achieving backward compatibility.

While the present invention has been described with reference to exemplary embodiments thereof, it will be understood by those skilled in the art that various changes in form and details may be made therein without departing from the scope of the present invention as defined by the following claims.

What is claimed is:

1. A method of transmitting a basic image frame and an additional optional frame in satellite digital multimedia broadcasting (S-DMB), the method comprising:
(a) generating the basic image frame and the optional frame by encoding an image;
(b) packetizing the basic image frame and the optional frame into a transport stream conforming to Motion Pictures Expert Group-2 (MPEG-2 ) standard and assigning a packet ID to the optional frame packet, the packet ID being different from that of the basic image frame packet; and
(c) generating a transport stream from the basic image frame packet and the optional frame packet having the packet ID and transmitting the transport stream.

2. The method of claim 1, further including (d) distributing the transport stream to input channels according to packet IDs to perform Code Division Multiplexing (CDM) for S-DMB transmission, wherein the optional frame packet is input to an input channel of the basic image frame packet or to another input channel according to the bit rate of the optional frame packet.

3. The method of claim 1, wherein, in the step (a), the optional frame is generated by making reference to the basic image frame and is not used as a reference frame for generating other frames.

4. The method of claim 3, wherein the basic image frame is an Intra-coded frame (I-frame) or a Predictively coded frame (P-frame), and the optional frame is a Bidirectionally predicted frame (B-frame).

5. A method of receiving S-DMB, the method comprising:
(a) receiving and demodulating code-division-multiplexed S-DMB data according to individual channels;
(b) collecting and restoring the demodulated data to a transport stream;
(c) demultiplexing and dividing the transport stream into a basic image frame packet and an optional frame packet that have different packet IDs from each other; and
(d) decoding both the basic image frame packet and the optional frame packet or only the basic image frame packet to generate an image according to whether or not a receiving apparatus can receive and decode the optional frame.

6. The method of claim 5, wherein the optional frame is generated by making reference to the basic image frame.

7. An apparatus for transmitting a basic image frame and an additional optional frame in S-DMB, the apparatus comprising:
a video encoder encoding an image to generate the basic image frame and the optional frame;
a packetization unit packetizing the basic image frame and the optional frame into a transport stream conforming to MPEG-2 standard and assigning a packet ID to the optional frame packet, the packet ID being different from that of the basic image frame packet; and
a multiplexing unit generating a transport stream from the basic image frame packet and the optional frame packet having the packet ID and transmitting the transport stream.

8. The apparatus of claim 7, further including a channel distribution unit distributing the transport stream to input channels according to packet IDs to perform CDM for S-DMB transmission, wherein the optional frame packet is input to an input channel of the basic image frame packet or another input channel according to the bit rate of the optional frame packet.

9. The apparatus of claim 7, wherein the optional frame is generated by making reference to the basic image frame and is not used as a reference frame for generating other frames.

10. An apparatus for receiving S-DMB, comprising:
a CDM demodulation unit receiving and demodulating code-division-multiplexed S-DMB according to individual channels;
a packet collecting unit collecting and restoring the demodulated data to a transport stream;
a demultiplexing unit demultiplexing and dividing the transport stream into a basic image frame packet and an optional frame packet that have different packet IDs from each other; and
a control unit decoding both the basic image frame packet and the optional frame packet or only the basic image frame packet to generate an image according to whether or not a receiving apparatus can receive and decode the optional frame.

11. The apparatus of claim 10, wherein the optional frame is generated by making reference to the basic image frame.
